(19) United States
(12) Patent Application Publication
(10) Pub. No.: US 2004/0205167 A1
(43) Pub. Date: Oct. 14, 2004

(54) Automatic configuration of performance management tools

(76) Inventor: Doug Grumann, Citrus Heights, CA (US)

Correspondence Address: HEWLETT-PACKARD COMPANY, Intellectual Property Administration, P.O. Box 272400, Fort Collins, CO, 80527-2400, US

(21) Appl. No.: 09/865,441

(22) Filed: May 29, 2001

(51) Int. Cl. G06F 15/177

(52) U.S. Cl. 709/220

(57) ABSTRACT

To achieve out-of-the-box performance management solutions in modern, complex computer environments, a method and an apparatus provide automatic discovery of applications and services resident on a monitored computer system and autonomous configuration of available performance management tools. The method includes inventorying installed applications, performance management tools, and active services. The inventory information is written to an ASCII-format file, and is used to generate performance management tool configuration files. The performance management software is then restarted to engage the new configuration customized to the computing environment.

### TECHNICAL FIELD

The technical field is software systems designed to monitor performance of a system.

### BACKGROUND

Performance of modern computer systems, including networked computer servers, may degrade for a variety of reasons, many of which relate to the use of shared resources including disk bandwidth, memory capacity, and central processing unit (CPU) utilization. Information technology (IT) system administrators track performance of their computer systems to ensure optimum allocation of these and other shared resources. Performance monitoring software provides system administrators with the tools necessary to track system performance and to diagnose problems. The performance monitoring software may provide performance information about a computer system, allow the administrator to examine the status of various services hosted by the computer system, identify and resolve bottlenecks, and tune the system and services for more efficient operation. The performance monitoring software may keep a history of the computer system performance, monitoring performance as a background task, and may send alarms for impending performance problems. Using the performance monitoring software, the administrator can pinpoint trends in computer system service levels, and can use this information to balance workloads to accurately plan for computer system growth.

Unfortunately, performance management software is typically complex, and takes a long time to master. Furthermore, performance management software commonly suffers from the inability to adapt to differing environments that the software is expected to monitor. Applications are mixed and configured differently on nearly every server, and server consolidation environments often support several disparate applications and services on a single system. Setup and custom configuration of performance tools specific to these different service environments is a burden on the system administrator, but is required to obtain value. Monitoring software that attempts to avoid this startup overhead suffers from the problem of being too generic to be useful in a modern, complex computing environment.

### SUMMARY

To achieve out-of-the-box performance management solutions in modern, complex computer environments, a method and an apparatus provide automatic discovery of applications resident and services active on a monitored computer system. The method and apparatus also provide autonomous, automatic configuration of available performance management tools.

Upon initiation of the method, specific information is obtained from the computer system under analysis. First, a discovery process to produce an inventory of installed applications is initiated. Different computing architectures have different mechanisms for obtaining this inventory information. The method and apparatus use the different mechanisms to produce an inventory of all installed applications.

Second, an inventory of performance management software is completed. The method and apparatus are flexible enough to provide automatic configuration of different management tools. Thus, the performance management tools present in the computer system must also be determined by a similar process as is used to discover resident applications.

Third, an inventory of active services is completed. For the purpose of this method, a service is considered an active instantiation of an application. For example, a database application may be installed on the computer system under analysis, and it might be instantiated in three separate instances, or services, to perform different functions. Likewise, some applications may be installed on a computer system yet not be activated. Configuration of performance tools may be dependent both upon the applications installed on the system, and the nature of how they are activated as services at any given time. Architecture-specific queries of active services, represented by running processes, are used to supplement the internal list of applications and flag some or all of them as services that are enabled or active. The automatically derived inventories of applications, performance tools, and active services that result from these first steps may then be written to an ASCII-format file.

Fourth, the inventories serve as input to a step that uses the awareness of the computing environment to generate configuration files specific to the performance management software present on the computer system. The configuration files include collection parameters, application-specific interfaces, performance thresholds, and alarms applicable to specific tools.

Fifth, and finally, the performance management software is restarted or reinitialized to engage the new configuration defined by the modified configuration files.

The method allows completion of the above-described steps without any manual intervention. For example, performance tool installation may invoke this method during the software install process to automatically configure the performance management tools to the computer system environment. If the computing environment changes, the method may be invoked on demand, or scheduled to execute periodically.

While in an embodiment, the method is entirely automatic; the automatic method may be supplemented manually by amending the output of the first three steps and then starting the process from the fourth step. This manual intervention can be provided without the requirement for manual setup and configuration.

### DESCRIPTION OF THE DRAWINGS

The detailed description will refer to the following drawings in which like numerals refer to like items, and in which:

FIG. 1 is a block diagram of an apparatus that provides for automatic configuration of performance management tools; and

FIG. 2 is a flow chart showing a method for automatic configuration of performance management tools.

### DETAILED DESCRIPTION

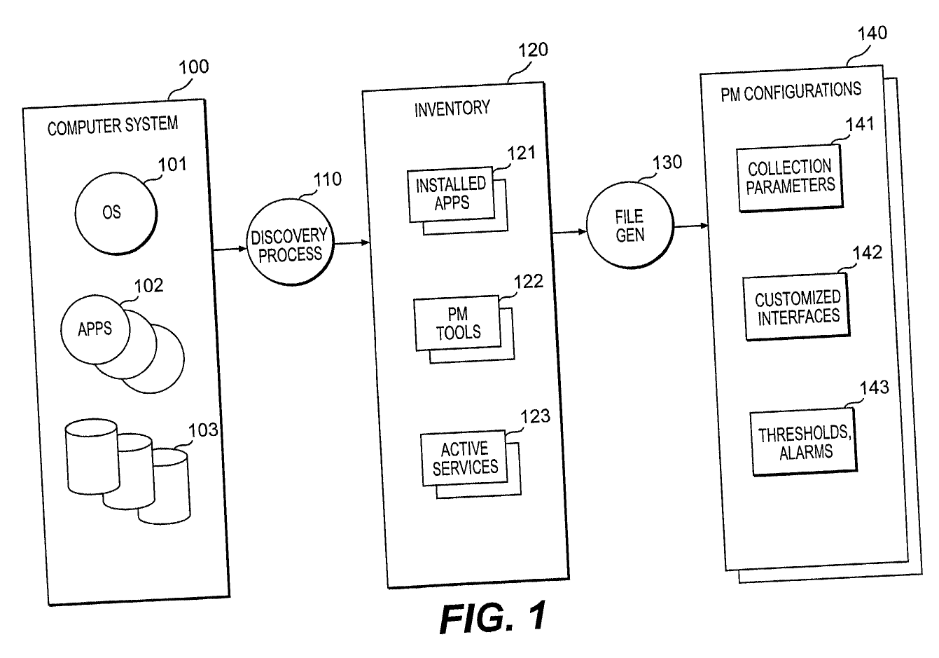

FIG. 1 is a block diagram of an exemplary apparatus that can be used for automatic configuration of performance management tools.

A computer system 100 environment includes operating or control systems (OS) 101 supplemented by applications 102 resident on storage media 103, which may include disk or networked storage. The computer system 100 has interfaces that allow specialized programs to discover installed applications. For example, using Windows NT, the OS 101 includes software to query a database of installed applications. This information includes registry information for installed performance management tools as well. On hp-ux, a Software Distributor tool may be used in an analogous fashion to derive an inventory of installed applications. Similar functionality exists in conjunction with all major Operating Systems. To augment this, programs may traverse mounted file systems and directories on disk and network media to determine which programs and applications are available to be executed on the system. When applications are added to the environment, an inventory is updated to reflect the addition. Thus, in an embodiment, a discovery process or module 110 can query a registration database or scan storage media to discover installed applications and to construct an ASCII (human-readable) inventory file 120 listing applications 121. This same procedure can be executed specifically to add to a performance management tool inventory 122 all of the performance management tools that are installed on the system.

During system operation, a varying number of installed applications 121 will be active at any one time. Executing applications compose services that are the function of a computer system. Services are composed of one or more processes executing programs specific to a given application. Some applications may be instantiated several different times to perform different services. In any case, computer system environments have interfaces (such as perflib on Windows NT, pstat on hp-ux) allow software to query the execution environment to discover which applications are currently active. Thus, in an embodiment, the discovery process 110 can supplement the inventory file 120 with information regarding active applications, or the current set of services instantiated 123.

The inventory file 120 may contain entries for each of the installed applications 121, the performance management tools 122, and the active services 123. Alternatively, the inventory file 120 may include an entry for all applications, and flags may be set to indicate an active application and performance tools. The discovery process 110 functions to maintain the inventory file 120 up-to-date. Thus, a complete inventory file 120 includes all possible services and performance tools in the environment along with information as to which services and tools are active.

The inventory file 120 thus generated may be edited by a system administrator. This step is allowed because the discovery process 110 may not be comprehensive, and the human-readable nature of the inventory allows for manual intervention based on the administrator's knowledge. In a current state of the art, system administrators need to manually configure performance tool configuration files directly, sometimes repeatedly and differently for every installed application and service. Allowing the administrator to embed this knowledge into a stable inventory allows for automation of much of this process.

A software module, or process, executing on the computer system may use the resulting inventories of installed applications 121, performance tools 122, and instantiated services 123 to generate configuration files specific to the computing environment. In an embodiment, a file generation process 130 uses the inventory file 120 to generate performance tool configuration files 140 specific to the performance management tools that are present on the system 100. The configuration files 140 thus generated may include collection parameters 141, application-specific interfaces 142, and performance thresholds/alarms 143 applicable to specific performance management tools.

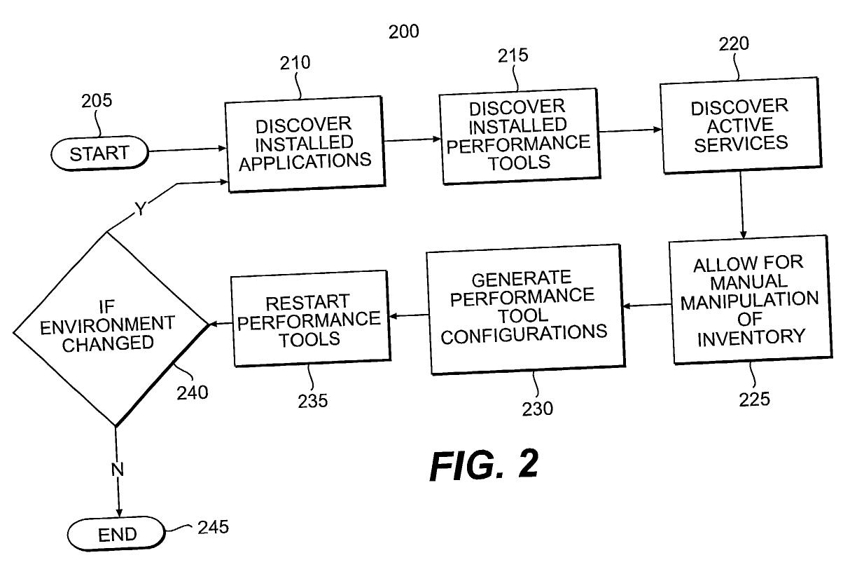

FIG. 2 is a flowchart showing one method according to the apparatus shown in FIG. 1. A process 200 is executed on the computer system 100, and begins at block 205, when the computer system 100 is started, or at some other time. In block 210, installed applications 121 are discovered by reading the system registry or by scanning attached storage devices on the computer system 100. In block 215, the same or a similar discovery process is used to add all installed performance management tools 122 to the inventory file 120. In block 220, the active process environment is examined to augment the inventory file 120 with active service 123 information. In an embodiment, the discovery processes 110 may be executed only periodically as new applications are added to the system 100, while the active service discovery may be executed on a frequent basis as the mix of running processes change. The augmented inventory file 120 thus created is maintained until updated by a subsequent inventory.

The inventory file 120, as an ASCII-format file, is available for viewing by an operator or administrator of the system, and may be printed. In block 225, the inventory file 120 itself may be edited by the administrator to change or add information relevant to the environment. Manual intervention is not required, however.

In block 230, the configuration file generation process 130 uses the inventory file 120 to create configuration files 140 specific to the performance management tools shown in the inventory steps (210, 215, 220). The configuration files 140 typically vary depending on particular performance management tool, but may include collection parameters, application-specific interfaces, performance thresholds, and alarms specific to the tool as well as the current operating service environment.

In block 235, the performance management software is reinitialized or restarted to engage the new configuration shown in the configuration files 140. Restarting the performance management software may be accomplished automatically, without intervention of the administrator, or would occur the next time the computer system is restarted. If the computing environment changes (for example, a new application is installed), the entire process can be re-iterated (block 240) in order to reflect the changes in the configuration files. If the process does not need to be repeated, the process then ends with block 245.

The above-described process is but one method for automatic configuration of performance management tools, and other methods may be used with the system shown in FIG. 1. The method illustrated in FIG. 2 may initiate automatically on start up of the system. The methods may also be initiated on demand by the system administrator, for example, when new hardware devices or application programs are added. The methods may also be initiated periodically to maintain optimum configuration of the performance management tools as the computer system evolves. For example, the methods may be initiated once per week, or more frequently.

1. A method for automatically configuring performance management software in a computer system, comprising:
inventorying applications and performance management tools;
generating an inventory list of the applications and the performance management tools;
using the inventory list, generating a performance management tools configuration; and
restarting the performance management software to engage the configuration of the performance management tools.

2. The method of claim 1, wherein the method is executed upon start up of the computer system.

3. The method of claim 1, wherein the method is executed on demand.

4. The method of claim 1, wherein the method is executed periodically.

5. The method of claim 1, wherein the method is executed automatically.

6. The method of claim 1, wherein the step of generating the inventory list comprises writing inventory information to an ASCII-format file.

7. The method of claim 1, wherein the step of generating the configuration file comprises specifying one or more of collection parameters, application-specific interfaces, performance thresholds, and alarms applicable to specific performance management tools.

8. The method of claim 1, wherein the inventory step comprises inventorying installed application programs and installed performance management tools.

9. The method of claim 8, further comprising inventorying active application programs and active performance management tools, wherein the active application programs and performance management tools are flagged to indicate an active status.

10. The method of claim 1, further comprising:
manually amending the inventory list; and
repeating the step of generating the performance management tools configuration.

11. The method of claim 1, further comprising storing the inventory list and the performance management tools configuration in a memory.

12. An apparatus that configures performance management tools in a computer system, comprising:
a registry that reads information from hardware devices, application programs, and performance management programs;
a kernel coupled to the registry that receives the information read by the registry and writes the information to an inventory file;
a file generator that receives the inventory file and information related to the computer system and generates a performance management tools configuration file; and
an operating system that restarts the performance management programs after generation of the configuration file.

13. The apparatus of claim 12, wherein the registry reads the information from hardware devices, application programs, and performance management programs automatically upon startup of the computer system.

14. The apparatus of claim 12, wherein the registry reads the information automatically and periodically during operation of the computer system.

15. The apparatus of claim 12, wherein the inventory file is an ASCII-format file.

16. The apparatus of claim 12, wherein the hardware devices, application programs and performance management tools are installed in the computer system.

17. The apparatus of claim 16, wherein one or more of the installed hardware devices, application programs and performance management tools are active, and wherein the kernel flags the active hardware devices, application programs and performance management tools.

18. The apparatus of claim 12, further comprising an interface that provides manual updating of the inventory file.

19. A method for configuring performance management tools in a computer environment, comprising:
discovering installed application programs in the computer environment;
discovering installed performance management tools in the computer environment;
discovering active application programs in the computer environment;
discovering active performance management tools in the computer environment;
generating an inventory file of the installed and the active application programs and performance management tools, wherein the active application programs and performance management tools are flagged;
generating a performance management tools configuration file based on features of the computer environment and the inventory file; and
restarting the performance management tools to engage the performance management tools.

20. The method of claim 19, wherein the discovering steps are performed automatically on startup of the computer environment, and further comprising:
manually amending the inventory file;
regenerating the performance management tools configuration file; and
restarting the performance management tools to engage the performance management tools, wherein the restarting step is performed after the regenerating step.
